(19) United States
(12) Patent Application Publication
(10) Pub. No.: US 2021/0156064 A1
(43) Pub. Date: May 27, 2021

(54) APPLICATOR APPARATUS FOR DYEING AND FINISHING

(71) Applicant: SAMWOODTP CO., LTD., Gyeonggi-do (KR)

(72) Inventor: Yoon Ho NAM, Gyeonggi-do (KR)

(21) Appl. No.: 15/734,629

(22) PCT Filed: Nov. 12, 2018
(86) PCT No.: PCT/KR2018/013720

§ 371 Date: Dec. 3, 2020

(30) Foreign Application Priority Data
Jun. 18, 2018 (KR) 10-2018-0069502

(51) Int. Cl. D06B 23/02; D06B 1/14; D06P 1/00

(52) U.S. Cl. CPC D06B 23/026; D06P 1/0036; D06B 23/023; D06B 1/146

(57) ABSTRACT

The present invention relates to an applicator apparatus for dyeing and finishing in which diagonal application grooves are formed in a longitudinal direction in an outer circumferential surface of a roller used to apply a chemical and reverse diagonal application grooves are formed to intersect the formed diagonal application grooves to allow the chemical to be evenly discharged to an outer circumferential surface of a pickup roller so that fabric dyeing efficiency is increased. The applicator apparatus for dyeing and finishing includes a storage tank (100) in which a chemical is accommodated, a guide roller (200) configured to guide a fabric (f) to be conveyed, a first pickup roller (300) which is installed at an upper portion of one side of the storage tank (100) and has an outer circumferential surface coming in contact with a surface of the fabric (f) being conveyed along the guide roller (200) and a lower portion dipped in the chemical accommodated in the storage tank (100) so that the chemical is attached to the outer circumferential surface and conveyed due to forward rotation of the first pickup roller (300), and an application roller (400) which is installed at an upper side of the first pickup roller (300), rotates in a reverse direction, and has diagonal application grooves (410) formed along an outer circumferential surface and reverse diagonal application grooves (420) formed to intersect the formed diagonal application grooves (410) so that the chemical conveyed along the first pickup roller (300) enters and passes through the formed diagonal application grooves (410) and reverse diagonal application grooves (420) and is guided to be evenly discharged to the outer circumferential surface of the first pickup roller (300) and applied to the fabric (f).

### TECHNICAL FIELD

The present invention relates to an applicator apparatus for dyeing and finishing in which diagonal application grooves are formed in a longitudinal direction in an outer circumferential surface of a roller used to apply a chemical and reverse diagonal application grooves are formed to intersect the formed diagonal application grooves to allow the chemical to be evenly discharged to an outer circumferential surface of a pickup roller so that fabric dyeing efficiency is increased.

### BACKGROUND ART

Generally, unlike a method in which an entire piece of fabric is dipped and finished in a water-repellent solution, one-side water repellent (or one-side water absorbent) finishing is fiber post-processing in which only one side of the fabric is treated to be water-repellent. Due to a characteristic of being able to impart both water-repellent and water-absorbent functions to the fabric, one-side water repellent (or one-side water absorbent) finishing may be usefully utilized for fabric finishing of functional clothing.

In particular, in recent years, there have been attempts to combine one-side water repellent finishing with finishing of fabric that uses threads having a sweat-absorbent quick-drying function, such as Aerocool and Coolmax. Thus, it is expected that the quality of sportswear or leisure clothing could be further improved in terms of ergonomics.

Meanwhile, a conventional chemical-and-moisture applicator apparatus, with which the one-side water repellent finishing technology is combined, (Patent Document 1) adopts a method in which a chemical aqueous solution or moisture is applied on a fiber surface so that moisture contained in a fiber fabric itself is minimized at the stage just before post-processing (drying and fixing of a chemical) of the fiber fabric using a tenter machine. In this way, an operation time of the post-processing device (tenter machine) is shortened and an advantage is provided in that energy is saved, but there is a problem in that the fabric may only be treated with highly viscous chemicals having a viscosity of about 1,000 cps.

Such a problem has been addressed through an applicator apparatus for one-side dyeing and finishing (Patent Document 2) that has been previously filed by the present applicant and for which the present applicant has been granted a patent.

FIG. 1 is a conceptual diagram illustrating the conventional applicator apparatus for one-side dyeing and finishing, and FIG. 2 is a detailed configuration diagram illustrating an application member among components constituting the conventional applicator apparatus for one-side dyeing and finishing.

As illustrated, the conventional applicator apparatus for one-side dyeing and finishing includes a storage tank 10 in which a low-viscosity chemical is accommodated, a pickup roller 20 which is installed at an upper portion of the storage tank 10 and has a surface dipped in the low-viscosity chemical so that the low-viscosity chemical is attached to an outer circumferential surface of the pickup roller 20 due to rotation thereof, a compression roller 30 which is installed at one side of the pickup roller 20 and configured to allow a fabric to pass by when in contact with the pickup roller 20 due to an operation of a compression control device and prevent passage of the fabric when separated from the pickup roller 20, and an application member 40 which is installed at an upper side of the pickup roller 20 and has application grooves 40a formed at right angles at predetermined intervals in a longitudinal direction.

The conventional applicator apparatus for one-side dyeing and finishing has a structure in which the low-viscosity chemical that is attached and conveyed along the pickup roller 20 is conveyed in a state in which the low-viscosity chemical is not evenly attached to the outer circumferential surface of the pickup roller 20.

Thus, the low-viscosity chemical being attached and conveyed is introduced into the circular application grooves 40a that are formed at predetermined intervals between every outer circumferential surface of the application member 40 so that the low-viscosity chemical is guided to be more evenly attached to the outer circumferential surface of the pickup roller 20.

However, due to the structural feature that the shape of the application grooves 40a formed in the application member 40 is circular, the low-viscosity chemical is re-attached to the outer circumferential surface of the pickup roller 20 in a concave-convex manner, and thus there is a problem in that efficiency of dyeing a fabric f is decreased.

Further, in the conventional applicator apparatus for one-side dyeing and finishing, in the case in which the low-viscosity chemical is used as a chemical (or a dyeing agent) accommodated in the storage tank 10, some of the low-viscosity chemical flows down from the pickup roller 20, along which the low-viscosity chemical is attached and conveyed, due to gravity, and thus it is essential to additionally supply the low-viscosity chemical.

Accordingly, there is a problem in that the conventional applicator apparatus for one-side dyeing and finishing should further include a storage tank 11 in which the low-viscosity chemical is separately stored, a pump 12 configured to provide a driving force to convey the low-viscosity chemical separately stored in the storage tank 11, and a nozzle 13 configured to additionally spray the low-viscosity chemical conveyed by the driving force of the pump 12 to the outer circumferential surface of the pickup roller 20.

Also, the conventional applicator apparatus for one-side dyeing and finishing has a structure in which, as the fabric f being conveyed passes between the pickup roller 20 and the compression roller 30, the low-viscosity chemical is applied to one surface of the fabric f.

Here, since a fabric contact area, which is an area in which the low-viscosity chemical is applied to the one surface of the fabric f, is a constant contact area between the pickup roller 20 and the compression roller 30, there is a problem in that it is not possible to control the fabric contact area to be increased or decreased according to the degree of viscosity of a chemical (whether the chemical has low viscosity or high viscosity) or control of a rotational speed of the pickup roller 20 and the compression roller 30.

Also, the conventional applicator apparatus for one-side dyeing and finishing has a problem in that there is no device for removing foreign substances generated from the fabric being conveyed during dyeing and finishing.

### DISCLOSURE

### Technical Problem

The present invention is directed to providing an applicator apparatus for dyeing and finishing in which diagonal application grooves are formed in a longitudinal direction in an outer circumferential surface of a roller used to apply a chemical and reverse diagonal application grooves are formed to intersect the formed diagonal application grooves to allow the chemical to be evenly discharged to an outer circumferential surface of a pickup roller so that fabric dyeing efficiency is increased.

The present invention is also directed to providing an applicator apparatus for dyeing and finishing in which, through a structure in which a pickup roller, along which a chemical is attached and conveyed due to rotation, is provided as a pair of pickup rollers in a storage tank storing the chemical and an application roller is disposed between the pair of pickup rollers so as to be pressed against and come in contact with the pair of pickup rollers, an accommodation space in which the chemical is accommodated is formed in two places so that the chemical may be smoothly supplied without an additional device for supplying the chemical.

The present invention is also directed to providing an applicator apparatus for dyeing and finishing in which a device for increasing or decreasing a width of a fabric contact area, which is an area in which a chemical is applied to one surface of a fabric, is provided, thus making it possible to control the fabric contact area, which is an area of the fabric that comes in contact with the dyeing chemical, to be increased or decreased according to the degree of viscosity of the chemical (whether the chemical has low viscosity or high viscosity) or control of a rotational speed of a pickup roller so that the dyeing efficiency is maximized.

The present invention is also directed to providing an applicator apparatus for dyeing and finishing that includes a device for removing foreign substances generated from the fabric being conveyed during dyeing and finishing.

### Technical Solution

An applicator apparatus for dyeing and finishing according to the present invention includes a storage tank in which a chemical is accommodated, a guide roller configured to guide a fabric to be conveyed, a first pickup roller which is installed at an upper portion of one side of the storage tank and has an outer circumferential surface coming in contact with a surface of the fabric being conveyed along the guide roller and a lower portion dipped in the chemical accommodated in the storage tank so that the chemical is attached to the outer circumferential surface and conveyed due to forward rotation of the first pickup roller, and an application roller which is installed at an upper side of the first pickup roller, rotates in a reverse direction, and has diagonal application grooves formed along an outer circumferential surface and reverse diagonal application grooves formed to intersect the formed diagonal application grooves so that the chemical conveyed along the first pickup roller enters and passes through the formed diagonal application grooves and reverse diagonal application grooves and is guided to be evenly discharged to the outer circumferential surface of the first pickup roller and applied to the fabric.

The applicator apparatus for dyeing and finishing according to the present invention may further include a second pickup roller which is installed at an upper portion of the other side of the storage tank so as not to come in contact with the first pickup roller and has a lower portion dipped in the chemical accommodated in the storage tank so that the chemical is attached to an outer circumferential surface of the second pickup roller and conveyed due to forward rotation of the second pickup roller, and the application roller, which is disposed in a region where the first pickup roller and the second pickup roller face each other, may come in contact with the first pickup roller and the second pickup roller due to its own weight so that a lower accommodation space is formed and the chemical, which is attached to the forward-rotating first pickup roller and conveyed, is accommodated in the formed lower accommodation space.

The first pickup roller and the second pickup roller may be made of a ferromagnetic material, and a permanent magnet may be inserted into the application roller so that the application roller is pressed against and comes in contact with the first pickup roller and the second pickup roller due to a magnetic force.

The chemical, which is attached to the forward-rotating second pickup roller and conveyed, may be accommodated in an upper accommodation space formed on the application roller, which is pressed against and comes in contact with the first pickup roller and the second pickup roller due to a magnetic force, and the second pickup roller.

The applicator apparatus for dyeing and finishing according to the present invention may further include a fabric contact area changing roller which is installed to be vertically movable, disposed to be spaced apart from the guide roller, and is moved upward or downward to control a width of a fabric contact area, which is an area of the fabric that comes in contact with the first pickup roller, to be increased or decreased.

The applicator apparatus for dyeing and finishing may further include a foreign substance removing part which is disposed in the storage tank and configured to filter foreign substances such as lint generated from the fabric being conveyed.

### Advantageous Effects

According to the present invention, diagonal application grooves are formed in a longitudinal direction in an outer circumferential surface of a roller used to apply a chemical and reverse diagonal application grooves are formed to intersect the formed diagonal application grooves to allow the chemical to be evenly re-attached to an outer circumferential surface of a pickup roller. In this way, there is an effect of increasing fabric dyeing efficiency.

Also, according to the present invention, through a structure in which a pickup roller, along which a chemical is attached and conveyed due to rotation, is provided as a pair of pickup rollers in a storage tank storing the chemical and an application roller is disposed between the pair of pickup rollers so as to be pressed against and come in contact with the pair of pickup rollers, an accommodation space in which the chemical is accommodated is formed in two places. In this way, there is an effect of smoothly supplying the chemical without an additional device for supplying the chemical.

Also, according to the present invention, a device for increasing or decreasing a width of a fabric contact area, which is an area in which a chemical is applied to one surface of a fabric, is provided, thus making it possible to control the fabric contact area, which is an area of the fabric that comes in contact with the dyeing chemical, to be increased or decreased according to the degree of viscosity of the chemical (whether the chemical has low viscosity or high viscosity) or control of a rotational speed of a pickup roller. In this way, there is an effect of maximizing the dyeing efficiency.

Also, according to the present invention, through a device for removing foreign substances generated from the fabric being conveyed during dyeing and finishing, there is an effect of removing foreign substances from a storage tank.

### DESCRIPTION OF DRAWINGS

FIG. 1 is a conceptual diagram illustrating a conventional applicator apparatus for one-side dyeing and finishing.

FIG. 2 is a detailed configuration diagram illustrating an application member among components constituting the conventional applicator apparatus for one-side dyeing and finishing.

FIG. 3 is a conceptual diagram illustrating an applicator apparatus for dyeing and finishing according to the present invention.

FIG. 4 is a detailed configuration diagram illustrating an application roller among components constituting the applicator apparatus for dyeing and finishing according to the present invention.

FIGS. 5 and 6 are views illustrating mounting of the application roller among the components constituting the applicator apparatus for dyeing and finishing according to the present invention.

FIG. 7 is a view illustrating formation of a lower accommodation space among the components constituting the applicator apparatus for dyeing and finishing according to the present invention.

FIG. 8 is a view illustrating formation of an upper accommodation space among the components constituting the applicator apparatus for dyeing and finishing according to the present invention.

FIGS. 9A to 9C are views illustrating a process in which a width of a fabric contact area is controlled to be increased or decreased using a fabric contact area changing roller among the components constituting the applicator apparatus for dyeing and finishing according to the present invention.

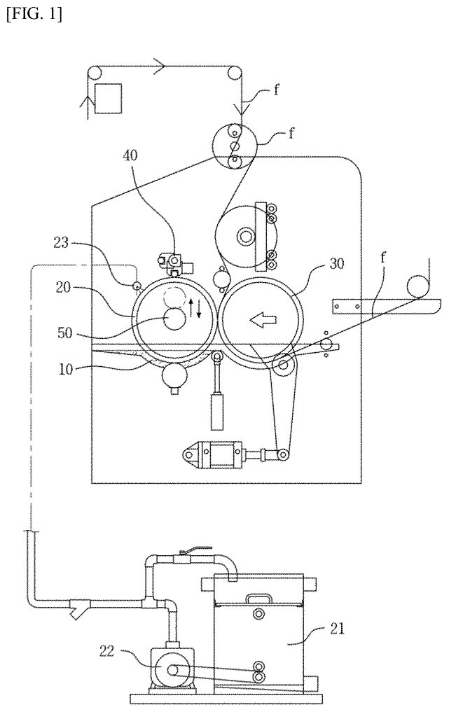

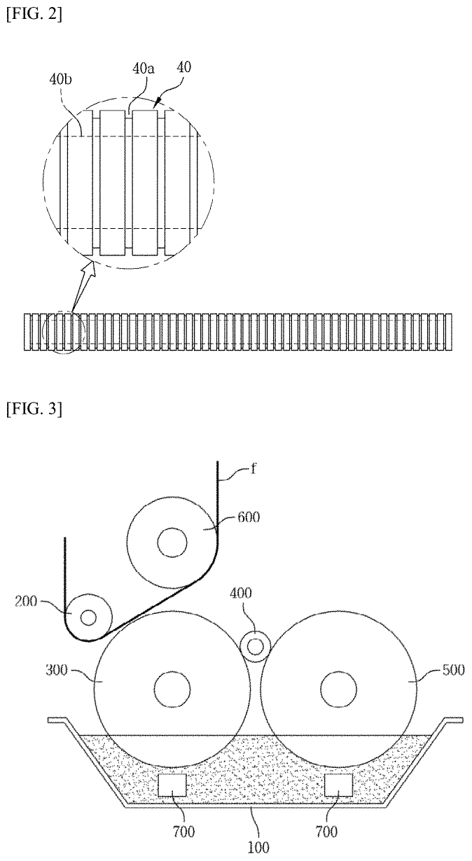

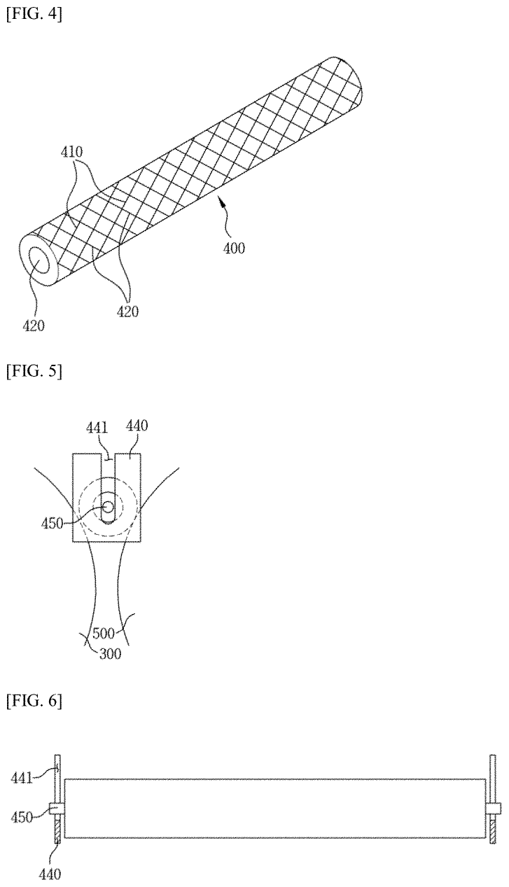

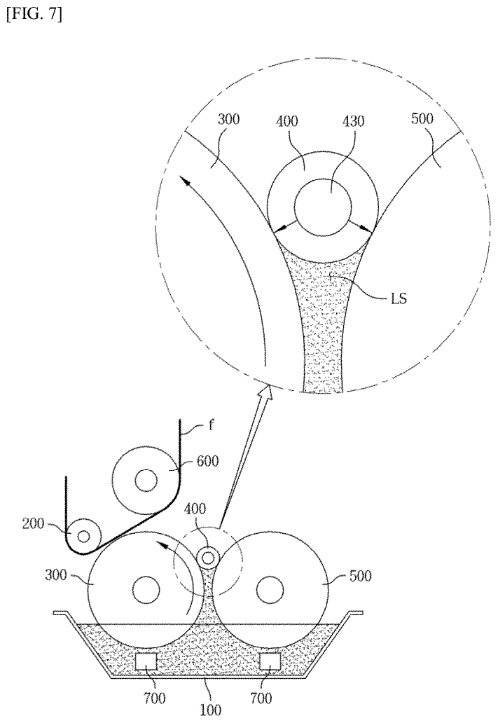

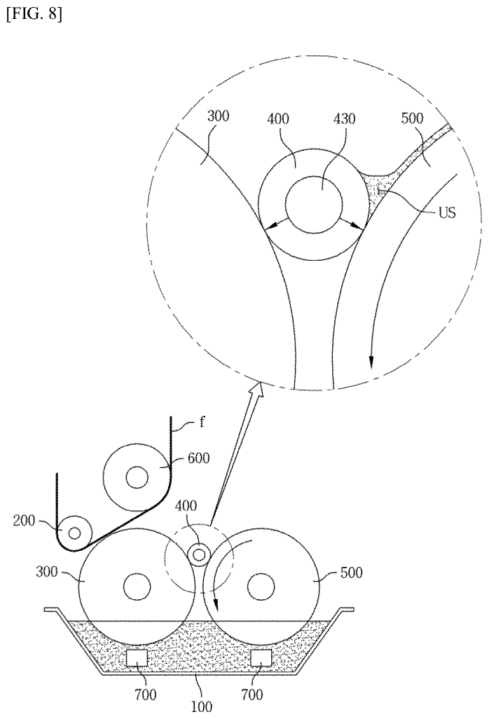

### MODES OF THE INVENTION

Hereinafter, configurations and actions of embodiments of the present invention will be described in detail with reference to the accompanying drawings.

As illustrated, an applicator apparatus for dyeing and finishing according to the present invention mainly includes a storage tank 100, a guide roller 200, a first pickup roller 300, and an application roller 400.

First, the storage tank 100 is a member configured to accommodate a chemical, which is a dyeing agent used to dye a fabric f. Here, the accommodated chemical may be a high-viscosity chemical, a low-viscosity chemical, or the like.

The guide roller 200 is a member which is installed to be fixed and is configured to guide the dyed fabric f to be conveyed through the first pickup roller 300 which will be described below.

The first pickup roller 300 is a member which is installed at an upper portion of one side of the storage tank 100 and has an outer circumferential surface coming in contact with a surface of the fabric f conveyed along the guide roller 200 and a lower portion dipped in the chemical accommodated in the storage tank 100 so that the chemical is attached to the outer circumferential surface and conveyed due to forward rotation of the first pickup roller 300.

The application roller 400 is a member which is installed at an upper side of the first pickup roller 300, rotates in a reverse direction opposite to the direction in which the first pickup roller 300 rotates, and has diagonal application grooves 410 formed along an outer circumferential surface and reverse diagonal application grooves 420 formed to intersect the formed diagonal application grooves 410 so that the chemical conveyed along the first pickup roller 300 enters and passes through the formed diagonal application grooves 410 and reverse diagonal application grooves 420 and is guided to be evenly discharged to the outer circumferential surface of the first pickup roller 300 and applied to the fabric f.

FIG. 10 is a table showing results of capturing shapes of canal-type blade grooves, which are the application grooves 40a formed in the conventional application member 40, and shapes of mesh-type blade grooves, which are the diagonal application grooves 410 and reverse diagonal application grooves 420 formed in the application roller 400 according to the present invention.

Since the application roller 400 according to the present invention has a structure in which the application grooves 410 and 420 intersect diagonally, the application roller 400 may guide the chemical entering the application grooves 410 and 420 to be more evenly discharged.

A wettability test was performed on the fabric f to confirm the degree of evenness of one-side finishing of the application roller 400. The wettability test was performed using the Sessile method by applying KS L2110:2006. The volume of water drops was set to 1 μL using a contact angle meter (DSA, KRUSS) in the

Sessile method, the fabric f was divided into four sections in the longitudinal direction, and a contact angle of droplets was measured in six sites for each section. Here, as the fabric f, a 100% polyethylene terephthalate (PET) single plain fabric finished to be one-side water repellent was used.

Table 1 shows the case in which the fabric f was divided into four sections in the longitudinal direction and six measurement sites were marked in each section.

Generally, as an intuitive indicator of wettability of a solid surface, measurement of contact angle θ of droplets is widely used, and being water-repellent refers to a case in which the contact angle θ of droplets is larger than or equal to 90°. Recently, θ in a range of 110° to 150° is evaluated as an indication of being highly water-repellent, and θ larger than 150° is evaluated as an indication of being super-highly water-repellent.

As a result of evaluating the degree of evenness of one-side finishing of the application roller 400, the average of all the contact angles was 151.0°±1.2° (the average of the contact angles in section 1 was 151.1°; the average of the contact angles in section 2 was 152.2°; the average of the contact angles in section 3 was 150.9°; and the average of the contact angles in section 4 was 149.8°). From this, it can be confirmed that the chemical was evenly applied to the fabric without any deviation in the left, middle, or right.

Table 2 below shows results of evaluating the contact angles of the fabric f by utilizing the application roller 400.

Meanwhile, in order to allow the chemical to be smoothly supplied to the application roller 400 without a separate device other than the storage tank 100 for supplying the chemical, the applicator apparatus for dyeing and finishing according to the present invention further includes a second pickup roller 500 which is installed at an upper portion of the other side of the storage tank 100 so as not to come in contact with the first pickup roller 300 and has a lower portion dipped in the chemical accommodated in the storage tank 100 so that the chemical is attached to an outer circumferential surface of the second pickup roller 500 and conveyed due to forward rotation of the second pickup roller 500.

In this way, the application roller 400, which is disposed in a region where the first pickup roller 300 and the second pickup roller 500 face each other, comes in contact with the first pickup roller 300 and the second pickup roller 500 due to its own weight so that a lower accommodation space LS is formed and the chemical, which is attached to the forward-rotating first pickup roller 300 and conveyed, is accommodated in the formed lower accommodation space LS.

Here, in order to allow the application roller 400 to come in contact with the first pickup roller 300 and the second pickup roller 500 due to its own weight, a mounting shaft 450 is additionally connected to both sides of the application roller 400, and a guide 440 having a vertical guide groove 441 formed therein is provided to allow vertical movement of the connected mounting shaft 450.

In this way, the mounting shaft 450 of the application roller 400 is guided to be vertically movable in the vertical guide groove 441 of the guide 440.

Also, in order to maintain the lower accommodation space LS and prevent disappearance thereof, the first pickup roller 300 and the second pickup roller 500 are made of a ferromagnetic material, and a permanent magnet 430 is inserted into the application roller 400 so that the application roller 400 is pressed against and comes in contact with the first pickup roller 300 and the second pickup roller 500 due to a magnetic force.

In particular, in order to allow a larger amount of chemical to be provided to the application roller 400 disposed between the first pickup roller 300 and the second pickup roller 500 to come in contact therewith, the chemical which is attached to the forward-rotating second pickup roller 500 and conveyed is accommodated in an upper accommodation space US formed on the application roller 400, which is pressed against and comes in contact with the first pickup roller 300 and the second pickup roller 500 due to a magnetic force, and the second pickup roller 500. In this way, the chemical may be smoothly supplied.

Meanwhile, in the applicator apparatus for dyeing and finishing according to the present invention, a device for increasing or decreasing a width of a fabric contact area, which is an area in which the chemical is applied to one surface of the fabric f, is provided, and thus a fabric contact area changing roller 600 is further provided to control the fabric contact area, which is an area of the fabric f that comes in contact with the dyeing fabric, to be increased or decreased according to the degree of viscosity of the chemical (whether the chemical has low viscosity or high viscosity) or control of a rotational speed of a pickup roller.

The provided fabric contact area changing roller 600 is installed to be vertically movable, is disposed above the guide roller 200 so as to be spaced apart from the guide roller 200, and is moved upward or downward to perform a function of controlling the width of the fabric contact area, which is an area of the fabric f that comes in contact with the first pickup roller 300, to be increased or decreased.

Here, the vertical movement of the fabric contact area changing roller 600 may be performed using various methods such as a rack-and-pinion method, a conveying screw method, or a cylinder method.

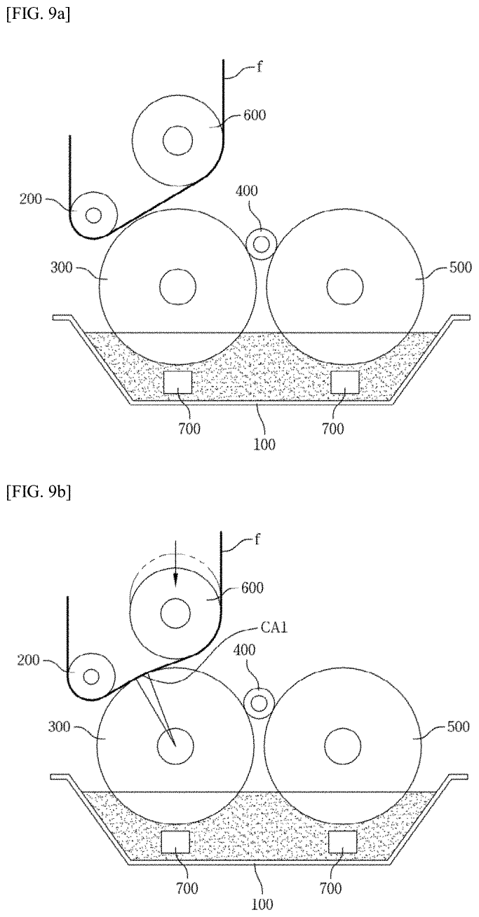

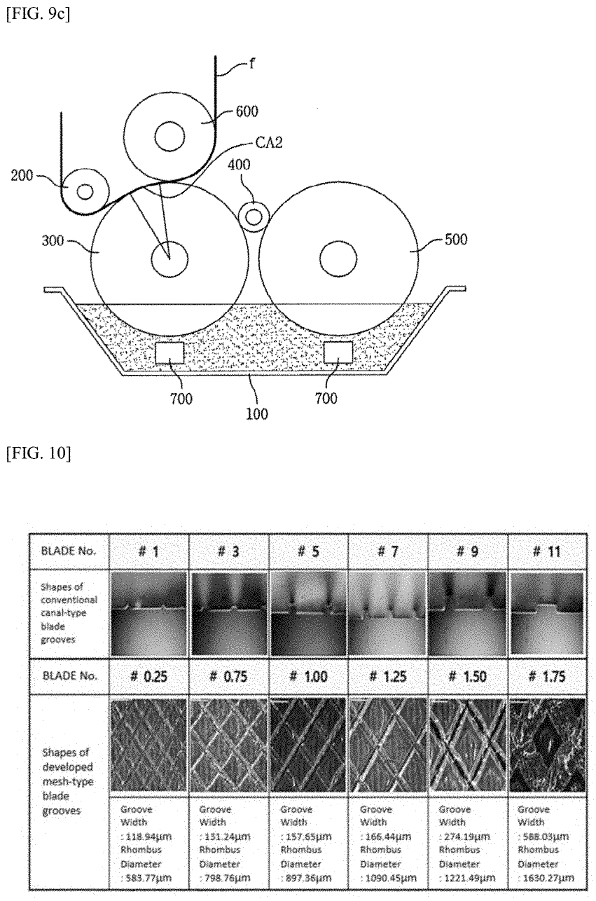

A process in which the width of the fabric contact area is controlled to be increased or decreased using the fabric contact area changing roller 600 will be described below with reference to FIGS. 9A to 9C.

Referring to FIG. 9A, the fabric contact area changing roller 600 is disposed at the uppermost side, and the fabric f on the fabric contact area changing roller 600 and the guide roller 200 is not in contact with the first pickup roller 300.

Referring to FIG. 9B, when the fabric contact area changing roller 600 disposed at the uppermost side is moved slightly downward, the fabric f on the fabric contact area changing roller 600 and the guide roller 200 comes in contact with the first pickup roller 300.

Here, a fabric contact area CA1 of the fabric f coming in contact with the first pickup roller 300 is narrow.

Referring to FIG. 9C, when the fabric contact area changing roller 600 disposed at an intermediate side is moved further downward, the fabric f on the fabric contact area changing roller 600 and the guide roller 200 comes in contact with the first pickup roller 300 to a greater extent. That is, a fabric contact area CA2 of the fabric f coming in contact with the first pickup roller 300 is wide.

In addition, a foreign substance removing part 700, which is configured to filter foreign substances when the foreign substances such as lint generated from the fabric f being conveyed fall therefrom, is installed and provided in the storage tank 100 of the applicator apparatus for dyeing and finishing according to the present invention.

The provided foreign substance removing part 700 consists of a silicone blade having a spring mounted thereon.

1. An applicator apparatus for dyeing and finishing, the applicator apparatus comprising:
a storage tank in which a chemical is accommodated;
a guide roller configured to guide a fabric to be conveyed;
a first pickup roller which is installed at an upper portion of one side of the storage tank and has an outer circumferential surface coming in contact with a surface of the fabric being conveyed along the guide roller and a lower portion dipped in the chemical accommodated in the storage tank so that the chemical is attached to the outer circumferential surface and conveyed due to forward rotation of the first pickup roller; and an application roller which is installed at an upper side of the first pickup roller, rotates in a reverse direction, and has diagonal application grooves formed along an outer circumferential surface and reverse diagonal application grooves formed to intersect the formed diagonal application grooves so that the chemical conveyed along the first pickup roller enters and passes through the formed diagonal application grooves and reverse diagonal application grooves and is guided to be evenly discharged to the outer circumferential surface of the first pickup roller and applied to the fabric (f).

2. The applicator apparatus of claim 1, further comprising a second pickup roller which is installed at an upper portion of the other side of the storage tank so as not to come in contact with the first pickup roller and has a lower portion dipped in the chemical accommodated in the storage tank so that the chemical is attached to an outer circumferential surface of the second pickup roller and conveyed due to forward rotation of the second pickup roller,
wherein the application roller which is disposed in a region where the first pickup roller and the second pickup roller face each other, comes in contact with the first pickup roller and the second pickup roller due to its own weight so that a lower accommodation space (LS) is formed and the chemical, which is attached to the forward-rotating first pickup roller and conveyed, is accommodated in the formed lower accommodation space (LS).

3. The applicator apparatus of claim 1, wherein the first pickup roller and the second pickup roller are made of a ferromagnetic material, and a permanent magnet is inserted into the application roller so that the application roller is pressed against and comes in contact with the first pickup roller and the second pickup roller due to a magnetic force.

4. The applicator apparatus of claim 3, wherein the chemical, which is attached to the forward-rotating second pickup roller and conveyed, is accommodated in an upper accommodation space formed on the application roller which is pressed against and comes in contact with the first pickup roller and the second pickup roller due to a magnetic force, and the second pickup roller.

5. The applicator apparatus of claim 1, further comprising a fabric contact area changing roller which is installed to be vertically movable, disposed to be spaced apart from the guide roller, and is moved upward or downward to control a width of a fabric contact area, which is an area of the fabric (f) that comes in contact with the first pickup roller, to be increased or decreased.

6. The applicator apparatus of claim 1, further comprising a foreign substance removing part which is disposed in the storage tank and configured to filter foreign substances such as lint generated from the fabric (f) being conveyed.
